(19) United States
(12) Patent Application Publication
(10) Pub. No.: US 2011/0018338 A1
(43) Pub. Date: Jan. 27, 2011

(54) HYDRAULIC BREAK SYSTEM

(76) Inventors: Martin Grepl, Aachen (DE); Helge Boehm, Ludwigsburg (DE)

Correspondence Address: MICHAEL J. STRIKER, 103 EAST NECK ROAD, HUNTINGTON, NY, 11743, US

(21) Appl. No.: 12/934,695

(22) PCT Filed: May 13, 2009
(86) PCT No.: PCT/DE2009/000684

§ 371 Date: Sep. 27, 2010

(30) Foreign Application Priority Data
May 14, 2008 (DE) 10 2008 023 476.1

(51) Int. Cl. B60T 8/48; B60T 8/176; B60T 8/1755; B60T 8/34

(52) U.S. Cl. 303/113.2

(57) ABSTRACT

The invention relates to a hydraulic brake system (1), comprising at least one brake valve (4, 98, 100), which can be manually actuated and by way of which a pressurized medium connection between at least one brake line (53, 54) connected by way of a pressurized medium connection to a wheel brake cylinder (26, 28, 30, 32) and a hydraulic accumulator (6, 8) can be opened. To this end, a wheel valve (16, 18, 20, 22, 102, 176, 178, 180, 182) is disposed between the wheel brake cylinder (26, 28, 30, 32) and the brake valve (4, 98, 100) in the pressurized medium flow path, wherein said wheel valve can be controlled by way of a circuit valve (34, 36, 184, 186, 210, 212) or a control element actuating the brake valve (4, 98, 100), regardless of the manual actuation of the brake valve (4, 98, 100). A plurality of brake circuits (94, 96) can be provided in the brake system, each being associated with a circuit valve 34, 36, 184, 186, 210, 212). The wheel and brake valves are furthermore either electrically controlled or pilot-controlled by hydraulics.

The invention relates to a hydraulic brake system according to the preamble of claim 1, a pilot control assembly for a brake system of that type, according to claim 8, and a hydraulic brake system according to claim 12.

Heavy vehicles that are used in construction, agriculture, and forestry, and special vehicles must include brake systems that have a high level of operational reliability despite low operating forces, especially for use on difficult terrain. In vehicles of this type, power brake systems are used in which the braking force is not applied directly by the driver, but rather directly via a hydraulic accumulator or the like. Hydraulic external force systems and pneumatic external force systems are basically known, although hydraulic systems are often preferred since it is very easy to supply energy via hydraulic systems that are already present on the vehicle, and since hydraulic components, in particular the wheel brake cylinder, require less space than pneumatic components, they allow highly precise applications to be carried out due to the low hysteresis involved, and they ensure short response times even at low temperatures.

Hydraulic power brake systems of this type are described in data sheet RD 66 226/06.00 from Mannesmann Rexroth AG. According to that data sheet, in a 2-circuit power brake system, a pressure medium connection between the wheel brake cylinders of the particular brake circuit and one hydraulic accumulator in each case is controlled open via a power brake system valve that is actuated using a brake pedal. The hydraulic accumulator is charged via an accumulator charge valve by a pump that supplies the brake system with pressure medium with priority over the other loads as soon as the accumulator pressure drops below a limit value. When the power brake system is actuated, the pressure in the wheel brake cylinders is regulated in proportion to the actuating force of the pedal. In the case of fast-moving vehicles in particular, the aim is to provide the power brake systems with an ABS functionality. Since the wheel brake cylinders of hydraulic power brake systems of this type have a very large intake volume, ABS systems from the automotive industry may not be used since their valves are designed for the small intake volumes of these brakes. Although ABS solutions for pneumatic power brake systems are known, they require a great deal of installation space due to the low energy density of compressed air, and they have the disadvantages described above. Hydraulic solutions are therefore preferred.

Publication WO 92/03321 discloses a brake system comprising a hydraulic antilock braking and traction control device for a vehicle. In this brake system, a wheel brake is actuated using a main brake cylinder during normal operation. When antilock braking or traction control is actuated, the main brake cylinder is disconnected via a directional control valve, and an ABS or TCS device is connected. It comprises a pump, a hydraulic accumulator, and an actuating device, and then controls the wheel brake independently of the main brake cylinder. This solution has the disadvantage that e.g. during ABS- and/or traction control, it is not possible to access the brake pressure of the main cylinder, but only the pressure of the ABS or TCS device, which is generated by the pump.

US 2005/0242660 likewise shows an antilock device and a traction control device of a brake system for a vehicle. In that case, the brake system comprises two brake circuits, each of which includes a hydraulic accumulator, wherein the brake circuits can apply pressure medium to the brake cylinders of two wheels independently of each other and via manual actuation of a power brake system by a vehicle driver. Furthermore, the ABS and TCS devices include a wheel valve for one brake cylinder each, the wheel valve being capable of controlling open the connection of the brake cylinder to the assigned brake circuit or a central functional valve. The functional valve opens a pressure medium connection between the wheel valve and a tank, or between the wheel valve and a further hydraulic accumulator, wherein, in the case of the latter pressure medium connection, the brake cylinders can be supplied with pressure medium independently of a manual actuation of a power brake system. The disadvantage of this is that both brake circuits are connected to a common functional valve, and they can therefore be operated either in the antilock mode or the traction control mode, but the two cannot be operated in different modes. In addition, the power brake system and the ABS and TCS devices each include a hydraulic accumulator, thereby resulting in a high level of device complexity.

Publication DE 10 2006 020 890 shows a brake system for ABS-, TCS-, and/or ESP-control. It comprises a hydraulic block having substantially more electromagnetically switchable valves, a hydraulic accumulator, and a hydraulic pump for the hydraulic control of a wheel brake cylinder with or without actuation of a power brake system. The power brake system is supplied with pressure medium by an accumulator charge valve and hydraulic accumulators connected thereto. The disadvantage of this solution is that the brake system has a highly complex design since the hydraulic block and the power brake system each require a pressure medium supply in the form of a hydraulic pump and a hydraulic accumulator.

In contrast, the object of the present invention is to create a brake system that has a simple design and can be used in a flexible manner.

This object is solved by a hydraulic brake system having the features of claim 1, a pilot control assembly for a brake system of that type, which has the features of claim 8, and a hydraulic brake system having the features of claim 12.

According to the invention, a hydraulic brake system includes at least one manually actuated brake valve, via which it is possible to control open a pressure medium connection between at least one brake line, which has a pressure medium connection to a wheel brake cylinder, and a hydraulic accumulator. A wheel valve and a circuit valve are disposed in the pressure medium flow path between the wheel brake cylinder and the brake valve. The wheel brake cylinder can be controlled closed via the wheel valve, or it can be connected to the brake valve or a tank, and the wheel valve can be connected via the circuit valve to the hydraulic accumulator independently of the manual actuation of the brake valve. In this configuration, two brake circuits are provided, for example, and a circuit valve is assigned to each brake circuit.

This solution has the advantage that the brake circuits can be controlled independently of each other, and by the brake valve via the particular circuit valves. It is therefore made possible to control the brake circuits of a vehicle in a highly individualized manner, wherein e.g. a brake circuit can be operated in an ABS mode, and the other can be operated in an ESP mode, and the brake circuits can be supplied with either brake pressure from the brake valve or the hydraulic accumulator.

The circuit valve is preferably an electrically or hydraulically continually adjustable 3-port directional control valve, the valve spool of which can be displaced out of a spring-loaded neutral position in the direction of a blocking position and a working position. In the neutral position of the circuit valve, the pressure medium connection between the wheel valve and the brake valve is controlled open, and, in the working positions, the pressure medium connection between the wheel valve and the hydraulic accumulator is controlled open. This is a cost-effective standard valve.

According to another preferred embodiment, the circuit valve is an electrically or hydraulically adjustable 2-port directional control valve comprising a valve spool. The valve spool is switchable from a spring-loaded blocking position into a working position, wherein, in the working position, the pressure medium connection between the hydraulic accumulator and the wheel valve is controlled open. The circuit valve is therefore an extremely simple and cost-effectively designed directional control valve.

In addition to the circuit valve, which is designed as a 2-port directional control valve, a further circuit valve can be provided, which is designed as an electrically or hydraulically adjustable, 2-port directional control valve. A valve spool of the second circuit valve is advantageously switched from a spring-loaded working position into a blocking position, wherein, in the working position, the pressure medium connection between the brake valve and the wheel valve is controlled open.

The wheel valve, similar to the circuit valve, is an electrically or hydraulically continually adjustable 3-port directional control valve, the valve spool of which is displaceable from a spring-loaded neutral position in the direction of a blocking position and a working position, wherein in the spring-loaded neutral position, the connection between the wheel brake cylinder and the circuit valve is controlled open and, in the working positions, the connection between the wheel brake cylinder and the tank is controlled open.

According to further preferred embodiment, the wheel valve is a cost-effective, electrically or hydraulically switchable 2-port directional control valve comprising a valve spool. The valve spool is switchable from a spring-loaded working position into a blocking position, wherein, in the working position, the connection between the wheel brake cylinder and the circuit valve is controlled open.

To relieve brake pressure from a wheel brake cylinder, a further wheel valve, which is designed as an electrically or hydraulically switchable, 2-port directional control valve comprising a valve spool is disposed in the pressure medium connection between the wheel brake cylinder and the wheel valve. This valve spool is switchable from a spring-loaded blocking position into a working position, wherein, in the working position, the connection between the wheel brake cylinder and the tank is controlled open.

The wheel valves and circuit valves can be easily controlled electromagnetically e.g. using an ECU (electronic control unit) via signal lines, or hydraulically via a pilot control assembly, wherein the latter solution enables higher forces to be generated for controlling the valves.

The valve spool of the wheel valve can be acted upon in the direction of the spring-loaded neutral position by a pilot control pressure of the pilot control assembly and, in the opposite direction, by pressure in the wheel brake cylinder, and the circuit valve can be acted upon in the direction of the spring-loaded neutral position by the pressure in the brake line between the circuit valve and the wheel valve, and in the opposite direction by a pilot control pressure from the pilot control assembly, thereby enabling the wheel and circuit valves to be controlled very rapidly.

The pilot control assembly is designed e.g. with inlet valves and outlet valves that are assigned to each of two brake circuits. Using the outlet valve, a pressure medium connection between at least one of the wheel valves and the tank can be controlled open, and, using the inlet valve, at least one wheel valve can be connected via a switching valve of the pilot control assembly to the brake valve or a high pressure control valve of the pilot control assembly. The high pressure control valve advantageously has a pressure medium connection to the hydraulic accumulator, and a circuit valve can be connected between the pressure medium flow path of the inlet valves and the switching valve and the high pressure control valve. A pilot control assembly of that type has the advantage that it can be supplied with pressure medium by the hydraulic accumulator of the brake system, thereby eliminating the need for a separate pump or accumulator element, for instance.

The inlet valves, outlet valves, switching valve, and the high pressure control valve are electrically continually adjustable 2-port directional control valves, which can be displaced from a spring-loaded neutral position in the direction of a working position or blocking position, thereby resulting in a very simple design of the pilot control assembly.

Two brake circuits advantageously each include two wheel valves and one circuit valve, and the brake circuits can be controlled jointly using one brake valve using a manual foot brake.

According to a further advantageous embodiment of the brake circuits, each one includes a circuit valve, a brake valve, a wheel valve, and a wheel valve that can be assigned to both brake circuits. The assignable wheel valve can be connected via a sequence valve to the brake circuit having the lower pressure. A “Y” braking circuit, which is often used e.g. in tractors, is thereby made possible.

A preferred embodiment of the hydraulic brake system includes at least one manually actuated brake valve, via which a pressure medium connection can be controlled open between at least one brake line, which has a pressure medium connection to a wheel brake cylinder, and a hydraulic accumulator, wherein a wheel valve is disposed in the pressure medium flow path between the wheel brake cylinder and the brake valve, via which the wheel brake cylinder can be controlled closed or connected to the brake valve or a tank. An ECU is used to control the wheel valve and can also control the brake valve, e.g. using an actuating device, independently of the manual actuation. A brake system having a simple design is thereby made possible, using which e.g. ABS or ESP control takes place independently of the manual actuation of the brake valve.

Advantageously, the brake valve can be actuated hydraulically or electrically using an actuating device.

The brake valve is hydraulically actuated using a pilot valve or circuit valve. Using this, it is possible to connect or disconnect a pressure medium connection between the hydraulic accumulator and the brake valve. To relieve a pilot pressure that actuated the brake valve, the brake valve can be relieved to the tank via a further circuit valve. The two circuit valves are preferably cost-effective and robust, electrically or hydraulically switchable 2-port directional control valves.

The wheel valve can be an electrically or hydraulically continually adjustable standard 3-port directional control valve, the valve spool of which is displaceable from a spring-loaded neutral position in the direction of a blocking position and a working position, wherein in the spring-loaded neutral position, the connection between the wheel brake cylinder and the brake valve is controlled open and, in the working positions, the connection between the wheel brake cylinder and the tank is controlled open.

Two braking circuits preferably each have two wheel valves and can be controlled jointly using one brake valve.

It is also possible for two brake circuits to each have a brake valve, a wheel valve, and a wheel valve that can be assigned to both brake circuits. The assignable wheel valve can be connected via a sequence valve to the brake circuit having the lower pressure.

The sequence valve is e.g. an inverse directional control valve, and the wheel valve is a cardan brake valve, thereby making it possible to realize “steering braking” e.g. of a tractor.

Advantageous developments of the invention are the subject matter of the dependent claims.

Preferred embodiments are explained below in greater detail with reference to the schematic drawings. They show:

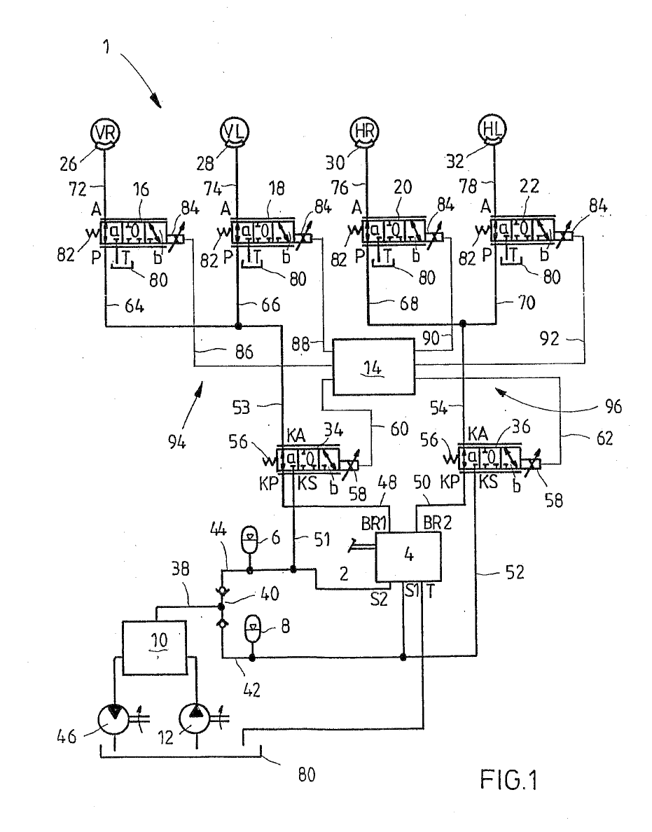

FIG. 1 a schematic circuit diagram of a hydraulic brake system according to a first embodiment;

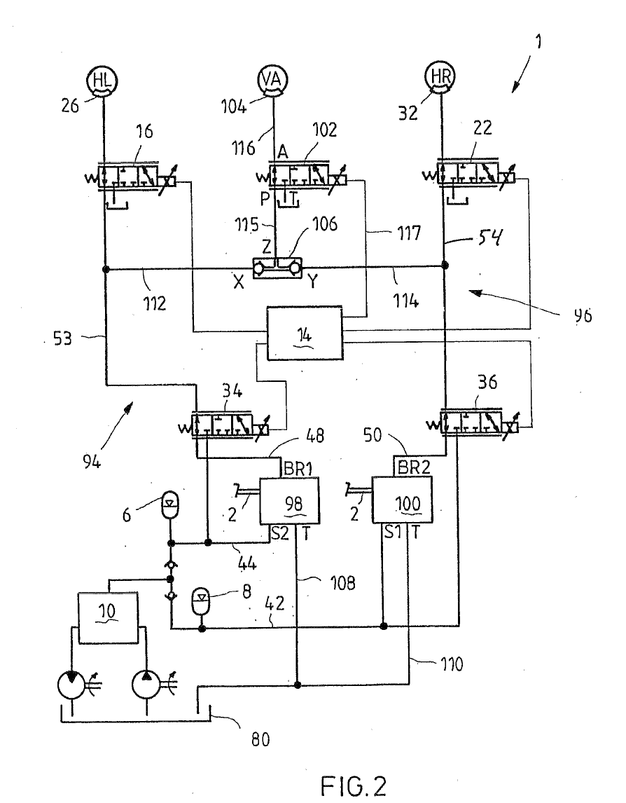

FIG. 2 a schematic circuit diagram of the hydraulic brake system according to a second embodiment;

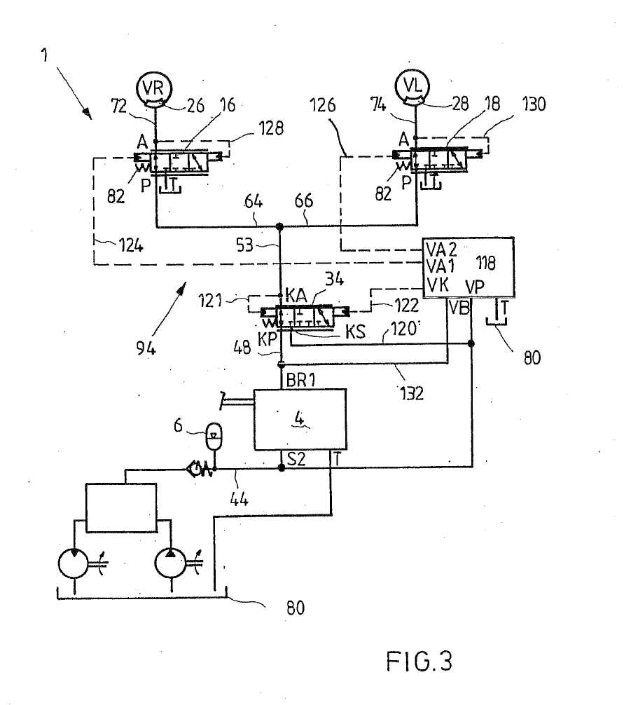

FIG. 3 a schematic circuit diagram of the hydraulic brake system according to a third embodiment;

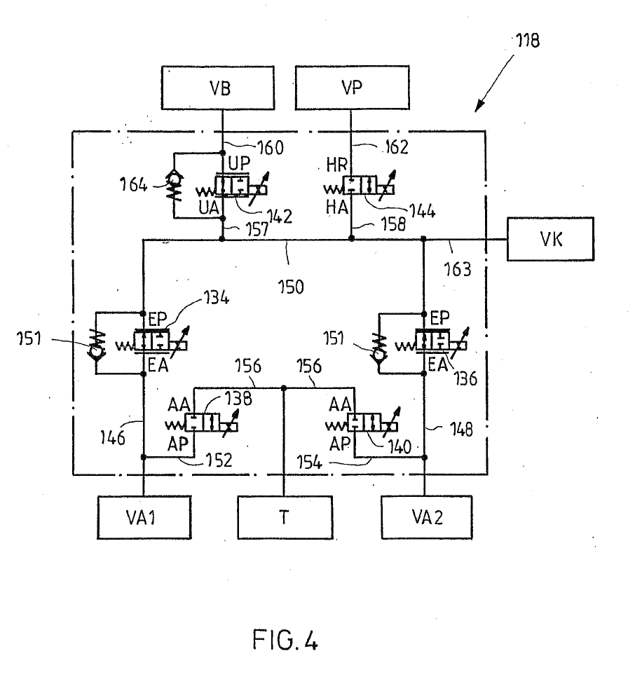

FIG. 4 a schematic circuit diagram of a hydraulic pilot control assembly of the braking system depicted in FIG. 3;

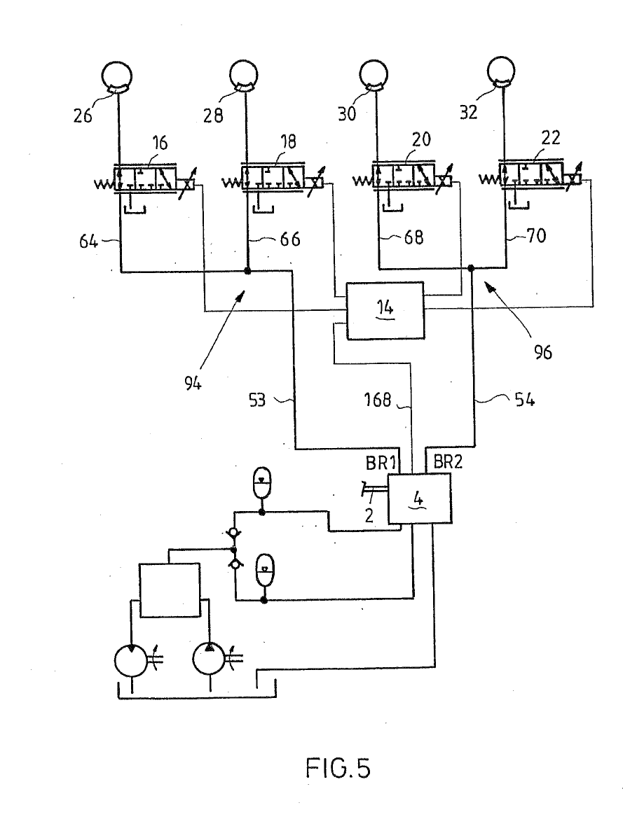

FIG. 5 a schematic circuit diagram the a hydraulic brake system according to a fourth embodiment;

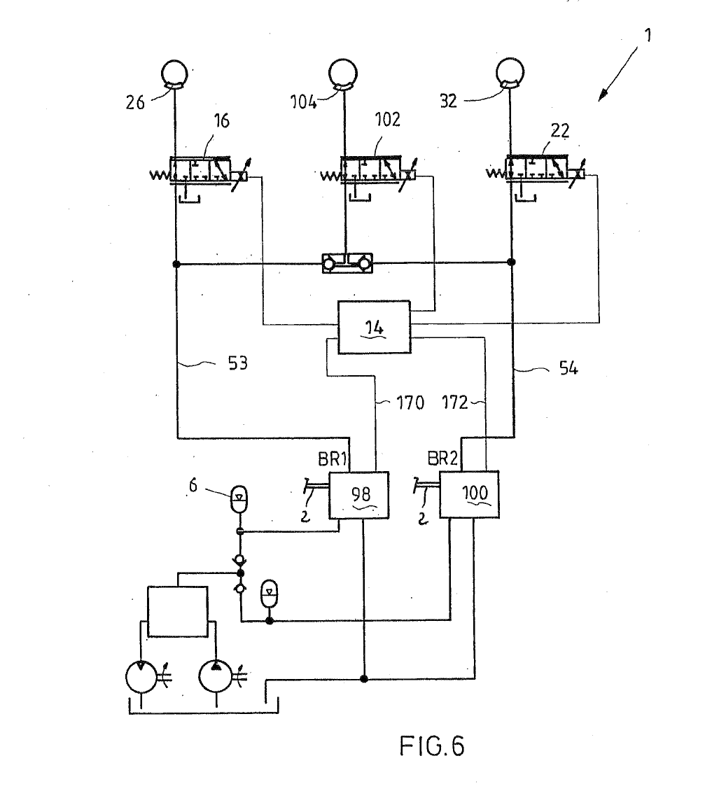

FIG. 6 a schematic circuit diagram the a hydraulic brake system according to a fifth embodiment;

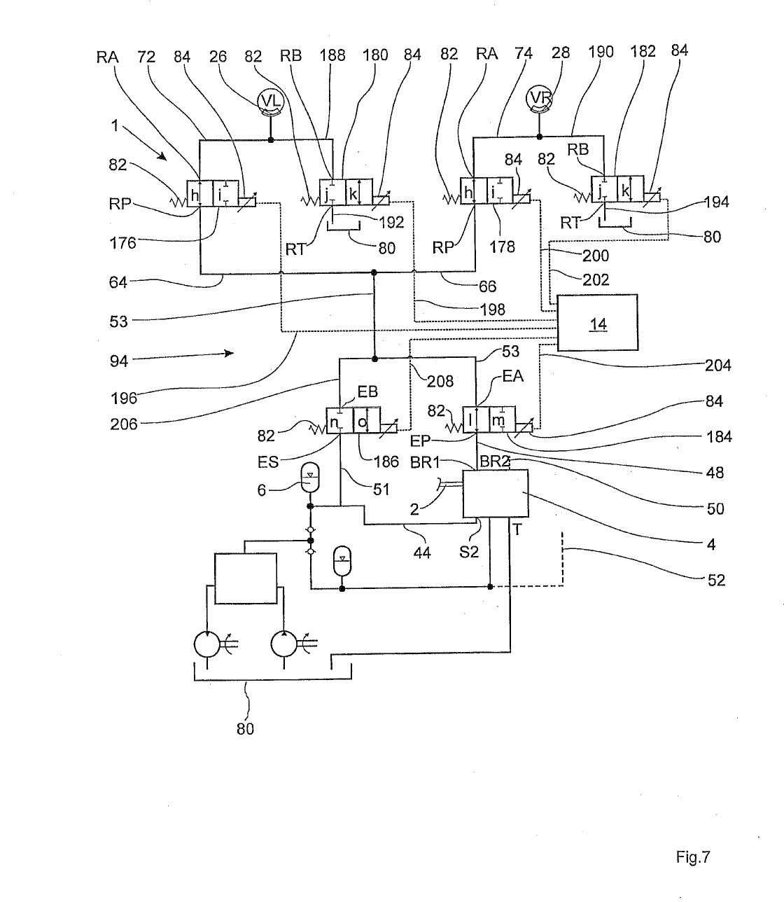

FIG. 7 a schematic circuit diagram the a hydraulic brake system according to a sixth embodiment;

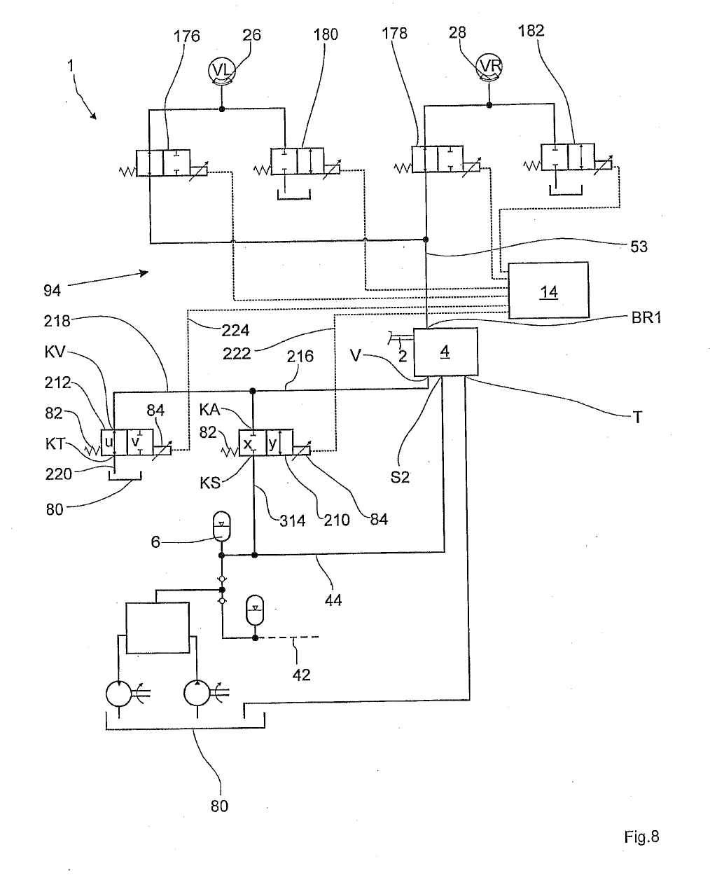

FIG. 8 a schematic circuit diagram of the hydraulic brake system according to a seventh embodiment;

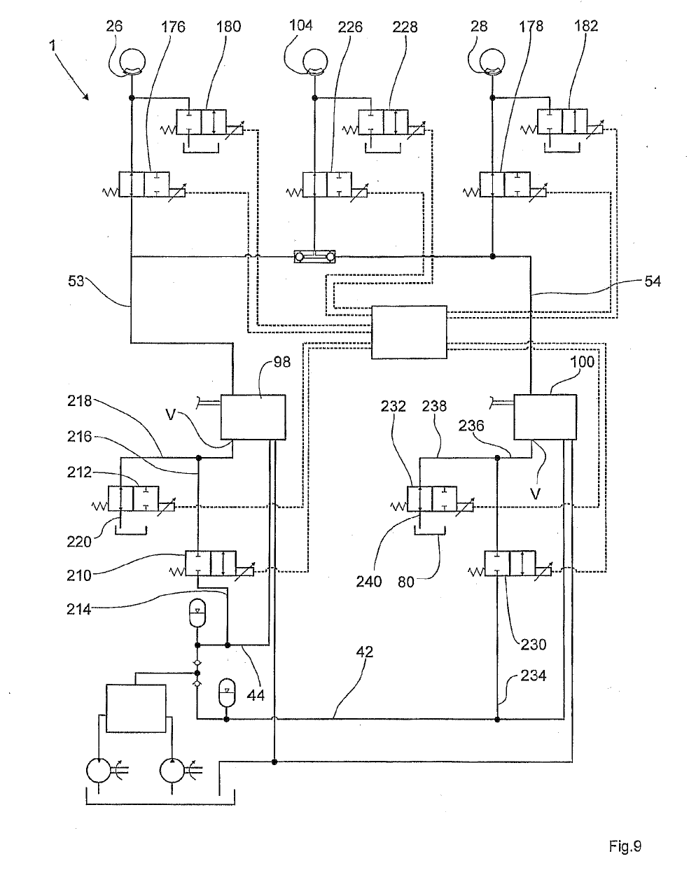

FIG. 9 a schematic circuit diagram of the hydraulic brake system according to an eighth embodiment.

FIG. 1 shows a schematic circuit diagram of a hydraulic brake system 1 according to a first embodiment, e.g., for a fast-moving tractor, a dump truck, or a communal vehicle, to realize ABS-, TCS-, and/or ESP-control. Brake system 1 is composed mainly of a brake valve 4, which is actuated using a brake pedal 2, two hydraulic accumulators 6, 8, an accumulator charge valve 10, a pump 12, an electronic control unit (ECU) 14, four wheel valves 16, 18, 20, 22, via which it is possible to apply brake pressure to one wheel brake cylinder 26, 28, 30, 32 each, and two circuit valves 34, 36, via which wheel valves 16, 18, 20, 22 can be supplied with pressure medium independently of brake valve 4. Wheel brake cylinders 26, 28 are assigned to wheels (VR, VL) of a front axle, and the two other wheel brake cylinders 30, 32 are assigned to wheels (HR, HL) of a rear axle.

The basic design of brake valve 4, which is actuated via brake pedal 2, and accumulator charge valve 10, and the connection to hydraulic accumulators 6, 8 is described extensively in aforementioned data sheet RD 66 226/06.00, and therefore only the elements that are essential to the understanding of the invention will be described here; as for the rest, reference is made to the disclosure in said data sheet.

Accumulator charge valve 10 serves the purpose of holding a pressure level within certain limit values in the accumulator circuit. When hydraulic accumulators 6, 8 are being charged, pump 12 pumps pressure medium into an accumulator supply line 38 which is connected to the inlet of an inverse directional control valve 40. Its two outputs are connected via accumulator lines 42, 44 to accumulator ports S1 and S2 of brake valve 4. Hydraulic accumulators 6, 8 are connected to accumulator supply lines 42 and 44, respectively. When a default pressure is reached, a pressure medium connection to a load port is controlled open via accumulator charging valve 10, thereby making it possible to supply a secondary load, which is indicated in FIG. 1 using reference numeral 46, with pressure medium. In terms of the description of the exact functionality of the accumulator charge valve, reference is made to the aformentioned data sheet, or to data sheet RD 66 191/08.04 from Bosch Rexroth AG.

Brake valve 4, or power brake valve, is a standard valve, e.g. of the type described in aforementioned data sheet RD 66 226/06.00, or in data sheet RD 66 146/10.03 from Bosch Rexroth AG. A brake valve 4 of this type includes aforementioned accumulator ports S1, S2, a tank port T, and brake ports BR1 and BR2 which are assigned to each brake circuit.

When brake pedal 2 is actuated, then, via brake valve 4, a pressure medium connection between accumulator ports S1, S2 and assigned output port BR1, BR2 is controlled open, thereby enabling brake pressure to build up in brake pressure lines 48, 50 which are connected to output ports BR1, BR2. Brake pressure lines 48, 50 are each connected to one pressure port KP of circuit valves 34, 36. Circuit valves 34, 36 furthermore each comprise an accumulator pressure port KS, wherein accumulator pressure port KS of circuit valve 34 is connected via a connecting line 51 to accumulator line 44, and accumulator pressure port KS of circuit valve 36 is connected via a connecting line 52 to accumulator line 42. Furthermore, circuit valves 34, 36 are connected via a respective outlet port KA to a wheel valve line 53, 54. Circuit valves 34, 36 are electrically continually adjustable 3-port directional control valves comprising a valve spool, which is preloaded by a spring 56 in a neutral position 0, working positions b and a blocking position a. In the direction of blocking position a and working position b, the valve spool of circuit valves 34, 36 can each be displaced against the force of spring 56 using an electromagnetic operating element 58 which is connected via an electrical signal line 60, 62 to ECU 14. In de-energized neutral position 0 of circuit valves 34, 36, outlet port KA is connected to pressure port KP, and accumulator pressure port KS is controlled closed, thereby establishing a pressure medium connection between brake pressure line 48, 50 and wheel valve line 53, 54 in each case. In blocking position a, all ports are controlled closed; in working positions b, wheel valve line 53, 54 is connected via outlet port KA to connecting line 51, 52, which is connected to accumulator pressure port KS, and outlet port KP is controlled closed.

Wheel valve lines 53, 54 each branch off into two supply lines 64, 66 and 68, 70, each of which is connected to a pressure port P of wheel valves 16 through 22, the design of which is described in greater detail below. Each wheel valve 16 through 22 has a brake port A which is connected via one brake line 72, 74, 76, 78 to assigned wheel brake cylinder 26, 28, 30, 32. Each wheel valve 16 through 22 also includes a tank port T which is connected to a tank 80. Wheel valves 16 through 22, similar to circuit valves 34, 36, are electromagnetically continually adjustable 3-port directional control valves comprising a valve spool that is preloaded in neutral position 0 using a spring 82, the valve spool being displaceable into working positions b and blocking position a against the acting direction of the spring force using an electrical operating element 84. Operating elements 84 of wheel valves 16, 18, 20 and 22 are each electrically connected via a signal line 86, 88, 90 or 92 to ECU 14. In de-energized, spring-preloaded neutral position 0 of wheel valve 16 through 22, brake port A has a pressure medium connection to pressure port P and, therefore wheel brake cylinders 26 through 32 have a pressure medium connection to lines 64 through 70. In blocking position a, brake-, pressure-, and tank ports A, P, T are controlled closed, and in working positions b, particular wheel brake cylinder 26 through 32 is connected, without pressure, via brake port A to tank port T, and pressure port P is closed.

Brake system 1 shown in FIG. 1 includes, in all, two brake circuits 94, 96, wherein brake circuit 94 shown on the left in FIG. 1 includes all components that are disposed in the pressure medium flow path in the direction of brake pressure build-up, starting from brake port BR1 of brake valve 4, and brake circuit 96 on the right includes the components in the direction of brake pressure build-up from brake port BR2 in a corresponding manner.

Wheel and circuit valves 16, 18, 20, 22, 34 and 36 are connected, as described above, via signal line 60, 62, 86, 88, 90 and 92, respectively, to ECU 14. ECU 14 is a central programmable control device that enables ABS-, TCS-, and/or ESP-control of brake system 1. The mode of operation of a control of that type has been known for some time from the prior art, and so means of controlling brake system 1 that are intended merely as examples will be explained below.

When braking is performed without an ABS-, TCS- and/or ESP-intervention of a vehicle equipped with brake system 1, wheel and circuit valves 16, 18, 20, 22, 34 and 36 are de-energized in their spring-loaded neutral position 0, as shown in FIG. 1. Wheel brake cylinders 26 through 32 therefore have a direct pressure medium connection to brake ports BR1, BR2 of brake valve 4. When brake valve 4 is actuated manually using brake pedal 2, the connection of brake ports BR1, BR2 to accumulator ports S1, S2 is controlled open, and wheel brake cylinders 26 through 32 are supplied with pressure medium from hydraulic accumulators 6, 8. When brake pedal 2 is released, brake ports BR1, BR2 are connected via tank port T of brake valve 4 to tank 80, and wheel brake cylinders 26 through 32 are relieved.

If the brake pressure specified by the vehicle driver using brake pedal 2 is too high and blocks one or more wheels of the vehicle, this brake pressure on the blocking wheels is relieved by controlling wheel valve 16, 18, 20 or 22 assigned to the blocking wheel in the direction of working positions b using ECU 14, thereby connecting corresponding wheel brake cylinder 26, 28, 30 and 32 to tank 80. When the blocking of one or more wheels has ended, corresponding wheel valve 16, 18, 20 or 22 is displaced once more in the direction of spring-loaded neutral position 0, and therefore corresponding wheel brake cylinder 26, 28, 30 or 32 is brought back into a pressure medium connection via brake valve 4 to hydraulic accumulators 6, 8, and is acted upon with brake pressure.

When control of brake system 1 is fully active (i.e. independently of the vehicle driver), circuit valves 34, 36 are controlled by the ECU into working positions b, thereby establishing the pressure medium connection of brake circuits 94, 96 to hydraulic accumulators 6, 8 independently of brake valve 4. It is also possible to displace only one of the two circuit valves 34, 36 in the direction of working position b. If e.g. pressure builds up in a single wheel brake cylinder 26 in brake circuit 94 shown on the left in FIG. 1, the valve spool of circuit valve 34 is displaced in the direction of working position b, and the valve spool of wheel valve 18, which is assigned to second wheel brake cylinder 28 in brake circuit 94, is displaced in the direction of blocking position a, and therefore wheel brake cylinder 26 is acted upon by brake pressure from hydraulic accumulator 6. If different setpoint brake pressures of two wheel brake cylinders 26, 28 should be realized in brake circuit 94, wheel brake cylinder 26, 28 having the higher brake pressure is controlled via circuit valve 34, and wheel brake cylinder 28 having the lower brake pressure is controlled via assigned wheel valve 18. This is used e.g. in ESP control. When brake pressure is reduced, electromagnetic operating element 84 is de-energized, and the valve spool of wheel and circuit valves 16, 18, 34 of brake circuit 94 is displaced in the direction of neutral position 0 and, therefore, wheel brake cylinders 26, 28 have a pressure medium connection to brake valve 4 and are connected by brake valve 4 to tank 80.

If the brake pressure specified by the vehicle driver using brake pedal 2 is not sufficient e.g. for ABS braking with subsequent ESP engagement, additional braking pressure is built up in brake circuits 94, 96 via hydraulic accumulator 6, 8 by switching circuit valves 34, 36 into working positions b.

If e.g. an interference occurs with the vehicle electrical system, brake circuits 94, 96 cannot be controlled using ECU 14, but normal braking function is still made possible by brake pedal 2 and brake valve 4.

FIG. 2 shows a schematic circuit diagram of hydraulic brake system 1 according to a second embodiment, in which a Y-branching of the brake circuits is realized, for tractors in particular, wherein rear wheels HL, HR of the rear axle each have a single wheel brake, and the front wheels of front axle VA has a central cardan shaft brake.

The pressure medium supply corresponds to that of the embodiment shown in FIG. 1, comprising mainly two hydraulic accumulators 6, 8 which are supplied with pressure medium by one accumulator charging valve 10. Furthermore, brake system 1 includes two brake valves 98, 100, each of which can be manually actuated using a brake pedal 2, for one of the brake circuits 94, 96 in each case. Brake circuits 94, 96 each have one circuit valve 34, 36 and one wheel valve 16, 22, via which brake pressure can be applied to a wheel brake cylinder 26, 32. Furthermore, a wheel valve or cardan brake valve 102, with which a wheel brake cylinder 104 has a pressure medium connection, and which can be assigned to one of the two brake circuits 94, 96, is disposed in brake system 1. Cardan brake valve 102 can be connected via a sequence valve or an inverse directional control valve 106 to brake circuit 94, 96 having the lower pressure. Valves 16, 22, 34, 36 and 102 are controlled via ECU 14. Cardan brake valve 102 corresponds to wheel valves 16 and 22 in terms of design and control.

Inverse directional control valve 106 has two input ports X, Y, each of which can be connected to a common output port Z. Input port X is connected to a valve line 112 which branches away from wheel valve line 53 upstream of wheel valve 16, and input port Y is connected accordingly to a valve line 114 that branches away from wheel valve line 54 upstream of wheel valve 22. Outlet port Z is connected to a supply line 115 which is connected to pressure port P of cardan brake valve 102. As mentioned above, cardan brake valve 102 corresponds to wheel valves 16, 22 and therefore has a working port A that has a pressure medium connection to wheel brake cylinder 104 via a brake line 116, and a tank port T. Furthermore, the valve spool of cardan brake valve 102 is displaceable from a spring-loaded neutral position 0, by energizing operating elements 84, in the direction of blocking position a and working position b, and furthermore cardan brake valve 104 can be controlled via signal line 117 via ECU 14. Inverse directional control valve 106 connects outlet port Z to respective inlet port X, Y at which the lower brake pressure exists, thereby establishing a pressure medium connection between cardan brake valve 102 and brake circuit 94, 96 having the lower brake pressure.

Brake valve 98 shown on the left in FIG. 2 is connected via accumulator port S2 to accumulator line 44, via brake port BR1 to brake pressure line 48, and via tank port T and tank line 108 to tank 80, thereby making it possible to control open a pressure medium connection between hydraulic accumulator 6 and brake circuit 94. Brake valve 100 shown on the right in FIG. 2 is connected, in a corresponding manner, via accumulator port S1 to accumulator line 42, via brake port BR2 to brake pressure line 50, and via tank port T and tank line 110 to tank 80, thereby making it possible to connect brake circuit 96 to hydraulic accumulator 8. Wheel and circuit valves 16, 22, 34, 36 and the pressure lines connected thereto are disposed according to the first embodiment, which is shown in FIG. 1, wherein supply line 64 in FIG. 1 corresponds to wheel valve line 53 in FIG. 2, and supply line 70 in FIG. 2 corresponds to wheel valve line 54 in FIG. 2.

The Y-branching of brake circuits 94, 96 shown in FIG. 2 makes “steering braking” possible, for tractors in particular. To reduce the turning circle of the tractor, e.g. on a field, only one of the two wheel brake cylinders 26, 32 of the rear wheel axle is braked via manual actuation of brake valve 98 or brake valve 100. When the tractor is driven on a road, both brake pedals 2 of brake valves 98, 100 are mechanically coupled, and therefore all wheel brake cylinders 26, 32, 104 are braked synchronously once more. The ABS- and/or TCR-control of brake circuit 1 shown in FIG. 1 corresponds substantially to that of the first embodiment shown in FIG. 1, and has been known for some time from the prior art, and will therefore not be described in greater detail here.

FIG. 3 shows a schematic circuit diagram of brake system 1 according to a third embodiment, in which wheel and circuit valves 16, 18, 34 are precontrolled hydraulically using a pilot control assembly 118. To this end, a modified brake circuit 94 of brake system 1 depicted in FIG. 1 will be described as an example in FIG. 3.

Brake circuit 94 shown in FIG. 3 has a brake valve 4 that has a pressure medium connection via accumulator port S2 and accumulator line 44 to hydraulic accumulator 6. Furthermore, tank port T is connected to tank 80, and brake port BR1 is connected to brake pressure line 48. Circuit valve 34 is connected thereto via pressure port KP, and via outlet port KA to branching wheel valve line 53. Accumulator pressure port KS of circuit valve 34 is connected to an accumulator line 120 that branches off of accumulator line 44. Circuit valve 34 is also acted upon in the direction of spring-loaded neutral position 0 via a signalling line 121 with the pressure in wheel valve line 53, and in the opposite direction with the pilot control pressure in a pilot control line 122 which has a pressure medium connection to a circuit valve port VK of pilot control assembly 118.

As also shown in FIG. 1, wheel valves 16, 18 are connected via pressure port P to supply line 64, 66, respectively, and via brake port A to brake line 72, 74, respectively. In addition to spring 82, wheel valves 16, 18 are acted upon in the direction of neutral position 0 with a pilot control pressure of a pilot control line 124, 126, and in the opposite direction with the brake pressure in a control line 128, 130 which tap the brake pressure at brake line 72, 74, respectively, which are assigned to wheel valves 16, 18, respectively. Pilot control line 124 of wheel valve 16 has a pressure medium connection with a wheel port VA1, and pilot control line 126 of wheel valve 18 has a pressure medium connection with a wheel port VA2 of pilot control assembly 118.

In addition to above-described circuit valve port VK and wheel ports VA1, VA2, pilot control assembly 118 also includes a brake pressure port VB which branches off from brake pressure line 48 via a pilot control brake line 132, a pilot control pressure port VP which is connected to hydraulic accumulator 6 via accumulator line 44, and a tank port T which is connected to tank 80. The design of pilot control assembly 118 is explained with reference to FIG. 4, which follows.

FIG. 4 shows a schematic circuit diagram of hydraulic pilot control assembly 128 of a brake system 1 depicted in FIG. 3. It includes inlet valves 134, 136 which are assigned to one wheel valve 16, 18 each, respectively, which are depicted in FIG. 3, and outlet valves 138, 140, a switching valve 142, and a high pressure control valve 144, wherein all valves of pilot control assembly 118 are designed as electrically continually adjustable, 2-port directional control valves.

Inlet valves 134, 136 are open in a neutral position 0, which is preloaded by a spring, and can be brought into a blocking position a by energizing a solenoid. In neutral position 0 of inlet valves 134, 136, a pressure line 150, which is connected to a pressure port EP of inlet valves 134, 136, has a pressure medium connection to an inlet line 146, 148, which is connected to an inlet port EA of inlet valves 134, 136, respectively. Inlet valves 146, 148 are connected via wheel ports VA1, VA2 to pilot control lines 124, 126 of wheel valves 16, 18 depicted in FIG. 3. A non-return valve 151, which is open in the direction of pressure line 150, is assigned to inlet valves 134, 136, to relieve pressure quickly from inlet lines 146, 148.

An outlet line 152, 154, each of which is connected to a pressure port AP of outlet valves 138, 140, branches off from inlet line 146, 148, respectively. Outlet valves 138, 140 are closed by the spring in neutral position 0, and can be displaced in the direction of an open working position s by energizing the solenoid. In working positions s of outlet valves 138, 140, outlet lines 152, 154 are connected to tank port T and, therefore, tank 80 shown in FIG. 3 via tank lines 156 which are connected to outlet ports AA of outlet valves 138, 140.

An outlet line 157 branches off from pressure line 150; outlet line 157 is connected to an outlet port UA of switching valve 142, and can be connected to brake pressure port VB via a pressure port UP of switching valve 142 with pressure line 160. As is the case with inlet valves 134, 136, the valve spool of switching valve 142 of switching valve 142 can be displaced from open, spring-loaded neutral position 0 in the direction of blocking position a by energizing the solenoid. Furthermore, an outlet line 158 that is connected to outlet port HA of high pressure control valve 144 branches off from pressure line 150. The valve spool of high pressure control valve 144 can be moved, by energizing the solenoid, from closed, spring-loaded neutral position 0 in the direction of open working position s, and establishes a pressure medium connection between outlet line 158 and a pressure line 162 connected to a pressure port HP of high pressure control valve 144, pressure line 162 being further connected to pilot control pressure port VP. Circuit valve port VK of pilot control assembly 118 likewise has a pressure medium connection to pressure line 150 via a pilot control line 163. A non-return valve 164 that is open toward pressure line 157 is assigned to switching valve 142 to relieve pressure more rapidly in outlet line 157.

The design of a pilot control assembly of that type is made possible e.g. via a simple modification of a hydraulic block from aforementioned publication DE 10 2006 020 890, which will be described briefly below. Instead of a hydraulic accumulator of the hydraulic block, which is usually present, tank port T of pilot control assembly 118 is formed. A non-return valve of the hydraulic block between an outlet valve and a return pump is omitted, and the connection is separated; a return pump and an electric motor are also omitted, for which circuit valve port VK of pilot control assembly 118 for circuit valve 34 shown in FIG. 3 is created. A high pressure control valve of the hydraulic block from the prior art is connected not to a brake valve or brake cylinder in a passenger car, but instead to hydraulic accumulator 6 via port VP of pilot control assembly 118 depicted in FIG. 3.

The mode of operation of pilot control assembly 118 will be explained below with reference to FIGS. 3 and 4. During normal braking, as described in the first embodiment depicted in FIG. 1, the brake pressure is switched through from hydraulic accumulator 6 to brake cylinder 26, 28 when brake valve 4 is actuated manually. Circuit valve 34 is held in spring-loaded neutral position 0 since brake pressure is present in both directions of displacement of the valve via signalling line 121 and pilot control line 122, wherein pilot control assembly 118 forwards the brake pressure via pilot control brake line 132, brake pressure port VB, open switching valve 142, and circuit valve port

KV directly to pilot control line 122. The same applies for wheel valves 16, 18. They are likewise held in spring-loaded neutral position 0 since the brake pressure acts in both directions of displacement of the valves. In one direction the brake pressure acts via control lines 128, 130, and in the other direction it acts via pilot control lines 124, 126, wherein the brake pressure is switched through via switching valve 142 and inlet valves 134, 136 of pilot control assembly 118.

If circuit valve 34 should be controlled in the direction of working positions b for direct connection to hydraulic accumulator 6 within the scope of ABS-, TCS-, and/or ESP-control when brake valve 4 is not actuated, switching valve and high pressure control valve 142, 144, respectively, of pilot control valve 118 are energized, and switching valve 142 is moved into blocking position a, and high pressure control valve 144 is moved into working position s. The brake pressure from hydraulic accumulator 6 therefore reaches pilot control line 122 via high pressure control line 144 and displaces circuit valve 34 via blocking position a toward working positions b, thereby controlling open a pressure medium connection of accumulator pressure port KS of circuit valve 34 via accumulator line 120 to hydraulic accumulator 6, and brake circuit 94 can be supplied with pressure medium. Wheel valves 16, 18 are therefore connected via brake valve 4 or circuit valve 34 to hydraulic accumulator 6.

If brake pressure is reduced e.g. by ABS control of brake pressure cylinder 28, inlet and outlet valves 134, 138, respectively, are switched, thereby blocking the pressure medium connection between pressure line 150 and inlet line 146, and opening the pressure medium connection between outlet line 152 and tank line 156. Pilot control line 126, which is connected to wheel port VA1 of pilot control assembly 118, is relieved toward tank 80, and therefore the valve spool of wheel valve 18 is displaced by the brake pressure of brake line 74, which is present in signal line 130 in the direction of its position labelled “b”, and, in blocking position a, the pressure medium connections between ports A, P, T are initially blocked via the control edges. In working position b, the brake pressure in brake lie 74 is reduced via tank port T toward tank 80. Via fast-switching valves 134, 138 of pilot control assembly 118, which are designed to be sufficiently large for the low control oil volumetric flows that occur, wheel valve 18, which is designed to accommodate a large volumetric flow of pressure medium, may therefore be switched very rapidly to build brake pressure or reduce brake pressure; the desired brake pressure is regulated by activating valves 134, 90 in a suitable manner.

The above-described ABS-, TCS-, and/or ESP-control by hydraulic pilot control 118 shown in FIGS. 3 and 4 are presented as examples. As is the case for the electrical activation of the valves in the first two embodiments presented in FIGS. 1 and 2, brake system 1 has all means of control that have been known for some time from the prior art.

Two further embodiments of brake system 1 are explained in FIGS. 5 and 6, below, in the case of which circuit valves 34, 36 shown in the previous figures were omitted.

FIG. 5 shows a schematic circuit diagram of hydraulic brake system 1 according to a fourth embodiment which substantially corresponds to the first embodiment shown in FIG. 1, without circuit valves 34, 36. In FIG. 5, wheel valve lines 53, 54 are connected directly to brake ports BR1 and BR2 of brake valve 4. Wheel valves 16, 18 of brake circuit 94 therefore have a pressure medium connection via wheel valve line 53 and via respective supply line 64, 66 to brake port BR1 of brake valve 4. The same applies for wheel valves 20, 22 of brake circuit 96, which are connected to brake port BR2 via wheel valve line 54 and supply lines 68, 70.

In contrast to the first embodiment shown in FIG. 1, ECU 14 is operatively connected to a signal line 168 having a brake valve 4, and can activate it using an electrical or hydraulic actuating device independently of the manual actuation of brake pedal 2. An electric motor or a pilot control piston can be used as the actuating device, for example.

By braking, independently of the manual actuation of brake pedal 2, brake pressure can be reduced in both brake circuits 94, 96 using brake valve 4 via the actuating device which is controlled by ECU 14. If e.g. only one wheel brake cylinder 26 should be acted upon with brake pressure, wheel valves 18, 20, and 22, which are assigned to the other wheel brake cylinders 28, 30, and 32, are controlled into blocking positions a and working positions b.

When different brake pressure requirements are placed on wheel brake cylinders 26, 28, 30 or 32, the highest required brake pressure is reduced via brake valve 4 in brake circuits 94, 96, and the brake pressure of wheel brake cylinders 26, 28, 30 or 32 having lower brake pressure demand is controlled using respective wheel valves 16, 18, 20, or 22.

A fifth embodiment of a schematic circuit diagram of hydraulic braking system 1 is shown in FIG. 6. This corresponds substantially to second embodiment 2 in FIG. 2, although it is designed similar to the fourth embodiment in FIG. 5 without circuit valves 34, 36 (see FIG. 2).

Wheel valve lines 53, 54 are connected directly to brake ports BR1 and BR2, respectively, of brake valves 98, 100. Brake valve 98 is operatively connected to ECU 14 via a signal line 170, and brake valve 100 is operatively connected to ECU 14 via a signal line 172, and are actuated electrically or hydraulically using an actuating device as shown in FIG. 5, it being possible to apply brake pressure from hydraulic accumulator 6 to wheel brake cylinders 26, 32 and 104 via wheel valves 16, 22 and cardan brake valve 102 independently of the manual actuation of brake pedal 2.

FIG. 7 shows a schematic circuit diagram of hydraulic brake system 1 according to a sixth embodiment. For simplicity, only brake circuit 94 for wheel brake cylinder 26 and 28 of wheels (VR, VL) of the front axle are shown. Assigned thereto are two 2-port directional control valves, as wheel inlet and wheel outlet valves 176, 178 and 180, 182, respectively, and as wheel valves, instead of a 3-port directional control valve, as shown in the first embodiment in FIG. 1. Furthermore, instead of a circuit valve 34, as shown in FIG. 1 and designed as a 3-port directional control valve, two 2-port directional control valves are disposed in brake system 1 as first and second circuit valve 184, 186, respectively.

Wheel inlet valves 176 and 178 for wheel brake cylinders 26 and 28 each have a pressure port RP, which is connected to supply line 64 and 66, and a brake port RA which is connected to brake line 72 and 74. An outlet line 188 and 190, each of which is connected to a brake port RB of wheel outlet valve 180 and 182, respectively, branches off from inlet line 72, 74, respectively. Each of these has a tank port RT which is connected to a tank line 192 and 194, wherein tank lines 192, 194 lead into tank 80.

Wheel inlet valves and wheel outlet valves 176, 178 and 180, 182, respectively, are each designed as electromagnetically actuated 2/2 switching valves. A particular valve spool of wheel inlet valves 176, 178 is preloaded via spring 82 in a neutral position h, in which pressure port RP has a pressure medium connection with brake port RA. Using electrical operating element 84, the valve spool can be switched to blocking position i, in which pressure port RP and brake port RA are separated from each other.

A valve spool of wheel outlet valves 180 and 182 is preloaded via spring 82 in a neutral position j, in which brake port RB is separated from tank port RT, thereby blocking the pressure medium connection between wheel brake cylinder 26 and 28 to tank 80. Via operating element 84, the valve spool of wheel outlet valves 180 and 182 can be switched to working position k, in which the pressure medium connection between wheel brake cylinder 26 or 28 and tank 80 is open.

Operating elements 84 are electrically connected to ECU 14 via signal lines 196, 198, 200, 202.

First and second circuit vales 184 and 186 are each designed as electromagnetically actuated 2/2 switching valves, as are wheel inlet valves and wheel outlet valves 176, 178 and 180, 182.

First circuit valve 184, which is shown on the right in FIG. 7, is connected via a pressure port EP to brake line 48 which is connected to outlet port BR1 of brake valve 4. First circuit valve 184 has a pressure medium connection with wheel valve line 53 via working port EA. A valve spool of first circuit valve 184 is preloaded via spring 82 in a working position I, in which pressure port EP is connected to working port EA and, therefore, brake line 48 is connected to wheel valve line 53. Via operating element 84, which is connected via signal line 204 to ECU 14, the valve spool of first circuit valve 184 can be switched to a blocking position m.

Second circuit valve 186, which is shown on the left in FIG. 7, is connected via an accumulator port ES to connecting line 51, which branches off of accumulator line 44, and via a working port EB to a connecting line 206, which is connected to wheel valve line 53. A valve spool of second circuit valve 186 is preloaded via spring 82 in a blocking position n, in which ports ES and EB do not have a pressure medium connection. Via operating element 84, which is connected via signal line 208 to ECU 14, the valve spool can be switched to a working position o, in which ports ES and EB have a pressure medium connection.

When braking is performed without an ABS-, ASR- and/or ESP-intervention of a vehicle equipped with brake system 1, wheel and circuit valves 176, 178, 180, 182, and 184, 186 are de-energized in their spring-loaded neutral position h, j, or n, l, as shown in FIG. 7. Wheel brake cylinders 26 and 28 have a direct pressure medium connection to brake port BR1 of brake valve 4. When brake valve 4 is actuated manually using brake pedal 2, the connection of brake port BR1 to accumulator port S2 is controlled open, and wheel brake cylinders 26 and 32 are supplied with pressure medium from hydraulic accumulator 6. When brake pedal 2 is released, brake port BR1 is connected via tank port T of brake valve 4 to tank 80, and wheel brake cylinders 26 and 28 are relieved.

If the brake pressure specified by the vehicle driver using brake pedal 2 is too high and blocks one or more wheels of the vehicle, this brake pressure on the blocking wheels is relieved by switching wheel outlet valve 180 or 182, which is assigned to the blocking wheel, into working position k, and switching wheel inlet valve 176 and 178 to blocking position i using ECU 14, thereby connecting corresponding wheel brake cylinder 26 or 28 to tank 80. When the blocking of one or more wheels has ended, corresponding wheel inlet valves and wheel outlet valves 176, 180, and 178, 182 are displaced once more in the direction of spring-loaded neutral position h, j, and therefore corresponding wheel brake cylinder 26 or 28 is brought back into a pressure medium connection via brake valve 4 to hydraulic accumulator 6, and is acted upon with brake pressure.

When control of brake system 1 is fully active (i.e. independently of the vehicle driver), first and second circuit valves 184 and 186 are switched by ECU 14 into positions m and o, respectively, thereby establishing the pressure medium connection of brake circuit 94 to hydraulic accumulator 6 independently of brake valve 4. If e.g. pressure builds up in single wheel brake cylinder 26 shown on the left in the figure, the valve spool of wheel inlet valve 178, which is assigned to the other, right-hand wheel brake cylinder 28 in brake circuit 94, is switched into blocking position i, and therefore brake pressure from hydraulic accumulator 6 is applied only to wheel brake cylinder 26.

If different setpoint brake pressures of two wheel brake cylinders 26, 28 should be realized in brake circuit 94, wheel brake cylinder 26 having the higher brake pressure is controlled via circuit valves 184, 186, and wheel brake cylinder 28 having the lower brake pressure is controlled via assigned wheel inlet valves and wheel outlet valves 178, 182.

If the brake pressure specified by the vehicle driver using brake pedal 2 is not sufficient e.g. for ABS braking with subsequent ESP engagement, additional braking pressure is built up in brake circuit 94 via hydraulic accumulator 6 by switching circuit valves 184 and 186 into positions m and o, respectively.

The second brake circuit, which is not depicted in FIG. 7, is designed similar to first brake circuit 94. The hydraulic connections to second brake circuit are indicated using brake pressure line 50 and connecting line 52, which are shown as dashed lines.

FIG. 8 shows a schematic depiction of brake system 1 according to a seventh embodiment. Only one brake circuit 94 is shown, as is the case for embodiment 6 described above with reference to FIG. 7. The difference from the last embodiment, shown in FIG. 7, is that a first and a second circuit valve 210, 212 are used as pilot valves and pilot control valves for brake valve 4. They are then used as a hydraulic actuating device for brake valve 4, as mentioned above in the description of the fourth embodiment (see FIG. 5). Circuit valves 210, 212 are designed as electromagnetically actuated 2/2 switching valves.

First circuit valve 210, which is shown on the right in FIG. 8, is connected via an accumulator port KS to an accumulator line 214 which branches off from accumulator line 44 connected to hydraulic accumulator 6. A pilot control line 216 is connected to a working port KA of circular valve 212, and has a pressure medium connection to a pilot control valve V of brake valve 4. A discharge line 218 branches off from pilot control line 216, and is connected to a valve port KV of second circuit valve 212. Tank connection KT of circuit valve 212 is connected to tank 80 via tank line 220.

A valve spool of first circuit valve 210 shown on the right in FIG. 8 is preloaded using spring 82 in a blocking position x. The valve spool of circuit valve 210 can be displaced into a working position y using operating element 84, which is connected to ECU 14 via a signal line 222; in working position y, hydraulic accumulator 6 has a pressure medium connection with pilot control port V of brake valve 4 via accumulator line 44, 214 and pilot control line 216.

A valve spool of second circuit valve 212 is preloaded via spring 82 in working position u, in which pilot control port V of brake valve 4 is connected to tank 80 via pilot control line 216, discharge line 218, and tank line 220. When the valve spool is displaced by operating element 84, which is connected to ECU 14 via a signal line 224, into a blocking position v, the pressure medium connection between pilot control port V and tank 80 is blocked by circuit valve 212.

For fully active control of brake system 1 depicted in FIG. 8, circuit valves 201, 212 are controlled via ECU 14. First circuit valve 210 is switched into working position y, and second circuit valve 212 is switched into blocking position v. As a result, brake valve 4 is connected to hydraulic accumulator 6 via first circuit valve 210, thereby applying a pilot control pressure or accumulator pressure to a pilot control of brake valve 4 via pilot control port V of brake valve 4, thereby opening brake valve 4. The opening causes wheel valve line 53, which is connected to outlet port BR1 of brake valve 4, to become connected to accumulator line 44 which is connected to accumulator port S2. If brake valve 4 were open, the second brake circuit, which is not depicted, would be connected to accumulator line 42, which is shown as a dashed line. The level of the pilot control pressure can be controlled by controlling circuit valves 210, 212.

If brake valve 4 has been opened by circuit valves 210, 212, wheel brake cylinders 26 and 28 have a pressure medium connection with hydraulic accumulator 6 via wheel inlet valves 176 and 178.

If only one of the wheel brake cylinders 26 or 28 should be actuated, the other—as described with reference to FIG. 7—is connected to tank 80 via opened wheel outlet valve 180 or 182, and is separated from hydraulic accumulator 6 via closed wheel inlet valve 176 or 178.

If different brake pressure is required at wheel brake cylinders 26, 28, the activation of brake valve 4 is controlled in accordance with the requirement of wheel brake cylinder 26, 28 having the highest pressure, via circuit valves 210, 212. Wheel brake cylinder 26 or 28 having the lowest pressure is controlled via wheel outlet valve 180 and 182, and wheel inlet valve 176 and 178.

If circuit valves 210, 212 are de-energized, the pilot control pressure of the pilot control of brake valve 4 is relieved toward tank 80, and the brake valve is closed once more, except that it is also actuated using brake pedal 2. When brake valve 4 is closed, the brake pressure in wheel brake cylinders 26, 28 is relieved via brake valve 4 toward tank 80.

A schematic circuit diagram of brake valve 1 according to an eighth embodiment is shown in FIG. 9. As in FIG. 8, wheel brake cylinders 26, 28 and 104 can be controlled using a wheel inlet valve 176, 178 or 226 and via a wheel outlet valve 180, 182 or 228.

The relieving of brake valve 1 corresponds approximately to the fifth embodiment shown in FIG. 6, with the difference that brake valves 98 and 100 can be actuated hydraulically using circuit valves 210, 212 or 230, 232, as is the case for brake valve 4 shown in FIG. 8.

Similar to the depiction shown in FIG. 8, first circuit valve 210 is connected via accumulator line 214 to accumulator line 44, and via pilot control line 216 to pilot control port V of brake valve 98. Second circuit valve 212 is connected to discharge line 218 and tank line 220.

First circuit valve 230 of the two other circuit valves 230, 232, which are assigned to second brake valve 100, is connected via accumulator line 234 to accumulator line 42, and via pilot control line 236 to pilot control port V of brake valve 100. Second circuit valve 232 has a pressure medium connection via discharge line 238 to pilot control line 236, and via tank line 240 to tank 80.

Brake valves 98 and 100 are controlled using circuit valves 210, 212 and 230, 232 in a manner corresponding to that for brake valve 4 having circuit valves 210, 212 depicted in FIG. 8.

As an alternative, instead of circuit valves 210, 212 or 230, 232 depicted in FIGS. 8 and 9, it is possible to use a 3/3 directional control valve as the pilot valve or circuit valve.

Wheel inlet valves 176, 178, 226, wheel outlet valves 180, 182, 222, and circuit valves 184, 186, 210, 212, 230, 232 are designed, in FIGS. 7, 8 and 9, as 2/2-directional control valves in the form of switching valves, although continually adjustable 2/2-directional control valves could also be used in this case.

A hydraulic brake system is disclosed that includes at least one brake valve which is manually actuated and via which it is possible to control open a pressure medium connection between at least one brake line, which has a pressure medium connection to a wheel brake cylinder, and a hydraulic accumulator. A wheel valve is disposed in the pressure medium flow path between the wheel brake cylinder and the brake valve, the wheel valve being controllable independently of the manual actuation of the brake valve via a circuit valve or an actuating device which actuates the brake valve. The brake system can include a plurality of brake circuits, to each of which a circuit valve is assigned. In addition, the wheel and brake valves are controlled electrically or pilot-controlled in a hydraulic manner.

### LIST OF REFERENCE CHARACTERS

1 Brake system
2 Brake pedal
4 Brake valve
6 Hydraulic accumulator
8 Hydraulic accumulator
10 Accumulator charge valve
12 Pump
14 Electronic Control Unit (ECU)
16 Wheel valve
18 Wheel valve
20 Wheel valve
22 Wheel valve
26 Wheel brake cylinder
28 Wheel brake cylinder
30 Wheel brake cylinder
32 Wheel brake cylinder
34 Circuit valve
36 Circuit valve
38 Accumulator supply line
40 Shuttle valve
42 Accumulator line
44 Accumulator line
46 Secondary load
48 Brake pressure line
50 Brake pressure line
51 Connecting line
52 Connecting line
53 Wheel valve line
54 Wheel valve line
56 Spring
58 Operating element
60 Signal line
62 Signal line
64 Supply line
66 Supply line
68 Supply line
70 Supply line
72 Brake line
74 Brake line
76 Brake line
78 Brake line
80 Tank
82 Spring
84 Operating element
86 Signal line
88 Signal line
90 Signal line
92 Signal line
94 Brake circuit
96 Brake circuit
98 Brake valve
100 Brake valve
102 Cardan brake valve
104 Wheel brake cylinder
106 Shuttle valve
108 Tank line
110 Tank line
112 Valve line
114 Valve line
115 Supply line
116 Brake line
117 Signal line
118 Pilot control assembly
120 Accumulator line
121 Signalling line
122 Pilot control line
124 Pilot control line
126 Pilot control line
128 Control line
130 Control line
132 Pilot control brake line
134 Inlet valve
136 Inlet valve
138 Outlet valve
140 Outlet valve
142 Switching valve
144 High pressure control valve
146 Inlet line
148 Inlet line
150 Pressure line
151 Non-return valve
152 Discharge line
154 Discharge line
156 Tank line
157 Outlet line
158 Outlet line
160 Pressure line
162 Pressure line
163 Pilot control line
164 Non-return valve
168 Signal line
170 Signal line
172 Signal line
176 Wheel inlet valve
178 Wheel inlet valve
180 Wheel discharge valve
182 Wheel discharge valve
184 Circuit valve
186 Circuit valve
188 Drain line
190 Drain line
192 Tank line
194 Tank line
196 Signal lines
198 Signal lines
200 Signal lines
202 Signal lines
204 Signal line
206 Connecting line
208 Signal lines
210 Circuit valve
212 Circuit valve
214 Accumulator line
216 Pilot control line
218 Drain line
220 Tank line
222 Signal line
224 Signal line
226 Wheel inlet valve
228 Wheel discharge valve
230 Circuit valve
232 Circuit valve
234 Accumulator line
236 Pilot control line
238 Drain line
240 Tank line
S1 Accumulator port
S2 Accumulator port
T Tank port
BR1 Outlet port
BR2 Outlet port
KS Accumulator pressure port
KA Outlet port
KP Pressure port
A Brake port
P Pressure port
X Inlet port
Y Inlet port
Z Outlet port
VA1 Wheel port
VA2 Wheel port
VP Pilot control pressure port
VB Brake pressure port
VK Circuit valve port
EA Inlet port
EP Pressure port
AP Pressure port
AA Discharge port
HA Outlet port
HP Pressure port
RP Pressure port
RA Brake port
RB Brake port
RT Tank port
EP Pressure port
EA Working port
ES Accumulator port
EB Working port
KS Accumulator port
KA Working port
KV Valve port
KT Tank port
V Pilot control port
0, h, j Neutral position
b, s, k, l, o, y, u Working position
a, l, m, n, x, v Blocking position

What is claimed is:

1. A hydraulic brake system comprising at least one manually actuated brake valve (4) via which it is possible to control open a pressure medium connection between at least one brake line (72, 74, 76, 78), which has a pressure medium connection to a wheel brake cylinder (26, 28, 30, 32), and a hydraulic accumulator (6, 8), wherein
the following are disposed in the pressure medium flow path between the wheel brake cylinder (26, 28, 30, 32) and the brake valve (4): a wheel valve (16, 18, 20, 22, 176, 178, 180, 182), via which the wheel brake cylinder (26, 28, 30, 32) can be controlled closed or connected to the brake valve (4) or a tank (80), and a circuit valve (34, 36, 186), via which the wheel valve (16, 18, 20, 22, 176, 178, 180, 182) can be connected to the hydraulic accumulator independently of the manual actuation of the brake valve (4), wherein at least two brake circuits (94, 96) are provided, characterized in that a circuit valve (34, 36, 186) is assigned to each brake circuit (94, 96).

2. The hydraulic brake system according to claim 1, wherein the circuit valve (34, 36) is an electrically or hydraulically continually adjustable 3-port directional control valve comprising a valve spool which can be displaced out of a spring-loaded neutral position (0) in the direction of a blocking position (a) and a working position (b), wherein, in the neutral position (0), the pressure medium connection between the wheel valve (16, 18, 20, 22) and the brake valve (4) is controlled open and, in the working positions (b), the pressure medium connection between the wheel valve (16, 18, 20, 22) and the hydraulic accumulator (6, 8) is controlled open.

3. The hydraulic brake system according to claim 1, wherein the circuit valve (186) is an electrically or hydraulically adjustable 2-port directional control valve comprising a valve spool which can be switched from a spring-loaded blocking position (n) into a working position (o), wherein, in the working position (o), the pressure medium connection between the hydraulic accumulator (6) and the wheel valve (176, 178) is controlled open.

4. The hydraulic brake system according to claim 3, wherein an additional circuit valve (184) is provided, which is designed as an electrically or hydraulically adjustable 2-port directional control valve, comprising a valve spool which can be switched from a spring-loaded working position (l) into a blocking position (m), wherein, in the working position (l), the pressure medium connection between the brake valve (4) and the wheel valve (176, 178) is controlled open.

5. The hydraulic brake system according to claim 1, wherein the wheel valve (16, 18, 20, 22) is an electrically or hydraulically continually adjustable 3-port directional control valve comprising a valve spool which can be displaced out of a spring-loaded neutral position (0) in the direction of a blocking position (a) and a working position (b), wherein, in the spring-loaded neutral position (0), the connection between the wheel brake cylinder (26, 28, 30, 32) and the circuit valve (34, 36, 184, 186) is controlled open and, in the working positions (b), the connection between the wheel brake cylinder (26, 28, 30, 32) and the tank (80) is controlled open.

6. The hydraulic brake system according to claim 1, wherein the wheel valve (176, 178) is an electrically or hydraulically switchable 2-port directional control valve comprising a valve spool which can be switched from a spring-loaded working position (h) into a blocking position (i), wherein, in the working position (h), the connection between the wheel brake cylinder (26, 28) and the circuit valve (184, 186) is controlled open.

7. The hydraulic brake system according to claim 6, wherein a further wheel valve (180, 182) comprising a valve spool is disposed in the pressure medium connection between the wheel brake cylinder (26, 28) and the wheel valve (176, 178), the wheel valve (180, 182) being designed as an electrically or hydraulically switchable 2-port directional control valve which can be switched from a spring-loaded blocking position (j) into a working position (k), wherein, in the working position (k), the connection between the wheel brake cylinder (26, 28) and the tank (80) is controlled open.

8. The hydraulic brake system according to claim 1, wherein the wheel valve (16, 18, 20, 22, 176, 178, 180, 182) and the circuit valves (34, 36, 186, 184) can be controlled open electromagnetically using an ECU (14).

9. The hydraulic brake system according to claim 1, wherein the wheel valves (16, 18, 20, 22) and the circuit valve (34, 36) of a brake circuit (94, 96) can be controlled open hydraulically using a pilot control assembly (118).

10. The hydraulic brake system according to claim 9, wherein the valve spool of the wheel valve (16, 18) is acted upon in the direction of the spring-loaded neutral position (a) by a pilot control pressure of the pilot control assembly (118), and in the opposite direction by the pressure in the wheel brake cylinder (26, 28).

11. The hydraulic brake system according to claim 9, wherein the valve spool of the circuit valve (34) is acted upon in the direction of the spring-loaded neutral position (a) by the pressure in the brake line (53) between the circuit valve (34) and the wheel valve (16, 18), and in the opposite direction by a pilot control pressure of the pilot control assembly (118).

12. The hydraulic brake system according to claim 1, wherein two brake circuits (94, 96) each have two wheel valves (16, 18, 20, 22), and the brake circuits (94, 96) are controlled jointly by one brake valve (4).

13. The hydraulic brake system according to claim 1, wherein two brake circuits (94, 96) each comprise one brake valve (4), one wheel valve (16, 18, 20, 22), and one wheel valve (16, 18, 20, 22) which can be assigned to both brake circuits (94, 96), wherein the assignable wheel valve (16, 18, 20, 22) can be connected to the brake circuit (94, 96) having the lower pressure using a sequence valve (106).

14. A pilot control assembly of a hydraulic brake system according to claim 1, comprising inlet valves (134, 136) and working valves (138, 140) assigned to each of two brake circuits (94, 96), wherein the outlet valve (138, 140) can be used to control open a pressure medium connection between at least one of the wheel valves (16, 18, 20, 22) and the tank (80), and wherein the inlet valve (134, 136) can be used to connect at least one wheel valve (16, 18, 20, 22) via a switching valve (142) of the pilot control assembly (128) to the brake valve (4) or a high pressure control valve (144) of the pilot control assembly (128),
characterized in that
the high pressure control valve (144) has a pressure medium connection with the hydraulic accumulator (6), and a circuit valve (34, 36) can be connected between the pressure medium flow path of the inlet valves (134, 136) and the switching valve (142) and the high pressure control valve (144).

15. The pilot control assembly according to claim 14, wherein the inlet valves (134, 136), the outlet valves (138, 140), the switching valve (142), and the high pressure control valve (144) are electrically continually adjustable 2-port directional control valves comprising a valve spool which can be displaced out of a spring-loaded neutral position (0) in the direction of a blocking position (a) or working position (s).

16. A hydraulic brake system comprising at least one manually actuated brake valve (4, 98, 100) via which it is possible to control open a pressure medium connection between at least one brake line (72, 74, 76, 78), which has a pressure medium connection to a wheel brake cylinder (26, 28, 30, 32), and a hydraulic accumulator (6, 8), wherein a wheel valve (16, 18, 20, 22, 176, 178, 180, 182, 226, 228) is disposed in the pressure medium flow path between the wheel brake cylinder (26, 28, 30, 32) and the brake valve (4), via which the wheel brake cylinder (26, 28, 30, 32) can be controlled closed or connected to the brake valve (4) or a tank (80), the wheel valve (16, 18, 20, 22, 176, 178, 180, 182, 226, 228) comprising an ECU (14) for controlling the wheel valve (16, 18, 20, 22), characterized in that the brake valve (4, 98, 100) can be controlled via the ECU (14) independently of the manual actuation.

17. The hydraulic brake system according to claim 16, wherein the brake valve (4, 98, 100) can be actuated hydraulically or electrically using an actuating device.

18. The hydraulic brake system according to claim 16, wherein the brake valve (4, 98, 100) can be connected to the hydraulic accumulator (6, 8) via a first circuit valve (210, 230) to be actuated using a pilot control pressure, or to the tank (80) via a second circuit valve (212, 232) to be relieved of the pilot control pressure.

19. The hydraulic brake system according to claim 18, wherein the first and the second circuit valve (210, 230) are each an electrically or hydraulically switchable 2-port directional control valve.

20. The hydraulic brake system according to claim 16, wherein the wheel valve (16, 18, 20, 22) is an electrically or hydraulically continually adjustable 3-port directional control valve comprising a valve spool which can be displaced out of a spring-loaded neutral position (0) in the direction of a blocking position (a) and a working position (b), wherein, in the spring-loaded neutral position (0), the connection between the wheel brake cylinder (26, 28, 30, 32) and the brake valve (4) is controlled open and, in the working positions (b), the connection between the wheel brake cylinder (26, 28, 30, 32) and the tank (80) is controlled open.

21. The hydraulic brake system according to claim 16, wherein two brake circuits (94, 96) each have two wheel valves (16, 18, 20, 22), and the brake circuits (94, 96) are controlled jointly by one brake valve (4).

22. The hydraulic brake system according to claim 16, wherein two brake circuits (94, 96) each comprise one brake valve (98, 100), one wheel valve (16, 22), and one wheel valve (102) which can be assigned to both brake circuits (94, 96), wherein the assignable wheel valve (102) can be connected to the brake circuit (94, 96) having the lower brake pressure using a sequence valve.

23. The hydraulic brake system according to claim 13, wherein the sequence valve (106) is an inverse directional control valve (106).

24. The hydraulic brake system according to claim 13, wherein the assignable wheel valve (102) is a cardan brake valve (102).
